(19) United States
(12) Patent Application Publication
(10) Pub. No.: US 2017/0081913 A1
(43) Pub. Date: Mar. 23, 2017

(54) SUNLIGHT SHADING STRUCTURE OF ROLLER CURTAIN

(71) Applicant: Tser Wen CHOU, Yorba Linda, CA (US)

(72) Inventor: Tser Wen CHOU, Yorba Linda, CA (US)

(21) Appl. No.: 14/861,157

(22) Filed: Sep. 22, 2015

(51) Int. Cl. E06B 9/264; E06B 9/386; E06B 9/34; E06B 9/40; E06B 9/62

(52) U.S. Cl. CPC E06B 9/264; E06B 9/40; E06B 9/62; E06B 9/34; E06B 9/386; E06B 2009/2435

(57) ABSTRACT

A roller curtain includes two suspending curtain sheets controlled by a curtain-controlling reel to move up and down, several layers of transverse curtain sheets interconnected between the suspending curtain sheets at intervals, and two weights disposed at lower ends of the suspending curtain sheets. Each transverse curtain sheet includes an upper sheet and a lower sheet. Two sides of the upper and lower sheets are bent to form different shading areas of sunlight shading fabric faces. The upper sheet is overlaid on the lower sheet and the sunlight shading fabric faces are sown on the two suspending curtain sheets at different heights to define a receiving space for placing therein a nontransparent sunlight shading fabric layer. When shading the sunlight, the suspending curtain sheets get closer to and attach to each other and the transverse curtain sheets become upright to shade the sunlight.

### BACKGROUND OF THE INVENTION

1. Field of the Invention

The present invention relates generally to a sunlight shading structure of roller curtain, and more particularly to a roller curtain structure with enhanced sunlight shading effect.

2. Description of the Related Art

A conventional roller curtain or zebra curtain structure is often such designed that the curtain sheets has transparent faces and light shading faces alternately arranged on the curtain sheets. The transparent face is aligned with another transparent face, whereby the sunlight can pass through the transparent faces into a room. When it is desired to shade the sunlight, the curtain sheets are adjusted to alternate the light shading faces. Under such circumstance, the sunlight is obstructed by the inner and outer light shading faces to achieve a sunlight shading effect.

In the conventional roller curtain or zebra curtain structure, the light shading faces are alternately positioned to obstruct the sunlight. Therefore, it is uneasy to adjust the curtain sheets to a position where the sun shading faces are completely aligned to fully obstruct the sunlight. As a result, it often takes place that the curtain sheets have some gaps and the sunlight passes through the gaps into the room to affect the sunlight shading effect.

### SUMMARY OF THE INVENTION

It is therefore a primary object of the present invention to provide a sunlight shading structure of roller curtain. The sunlight shading structure includes two suspending curtain sheets controlled by a rotational curtain-controlling reel to move up and down, several layers of transverse curtain sheets interconnected between the suspending curtain sheets at equal intervals, and two lower weights disposed at lower ends of the suspending curtain sheets. The sunlight shading structure is characterized in that each transverse curtain sheet includes an upper sheet and a lower sheet. Two sides of the upper and lower sheets are bent to form different shading areas of sunlight shading fabric faces. Then the upper sheet is overlaid on the lower sheet and the sunlight shading fabric faces are sown on the two suspending curtain sheets at different heights to define a receiving space for placing therein a nontransparent sunlight shading fabric layer. Accordingly, two sides of the upper and lower sheets have different sunlight shading areas of sunlight shading fabric faces. When shading the sunlight, the suspending curtain sheets get closer to and attach to each other and the transverse curtain sheets become upright to shade the sunlight. At this time, the lateral sunlight shading fabric faces are vertically overlapped with each other to avoid any gap between the two suspending curtain sheets. In this case, there is no gap between the two suspending curtain sheets for the sunlight to pass through so that the sunlight shading effect is enhanced.

The present invention can be best understood through the following description and accompanying drawings, wherein:

### BRIEF DESCRIPTION OF THE DRAWINGS

FIG. 1 is an exploded view of the curtain sheets of the present invention;

FIG. 2 is an assembled view of the curtain sheets of the present invention;

FIG. 3 is a perspective view showing the installation of the curtain sheets of the present invention;

FIG. 4 is a perspective view showing the arrangement of the curtain sheets of the present invention;

FIG. 5 is a front view of the roller curtain of the present invention;

FIG. 6 is a front view of the roller curtain of the present invention according to FIG. 5, showing that the curtain-controlling reel is counterclockwise rotated;

FIG. 7 is a front view according to FIG. 6, showing that the suspending curtain sheets attach to each other to shade the sunlight;

FIG. 8 is a view showing that the sunlight is obstructed by the sunlight shading fabric faces;

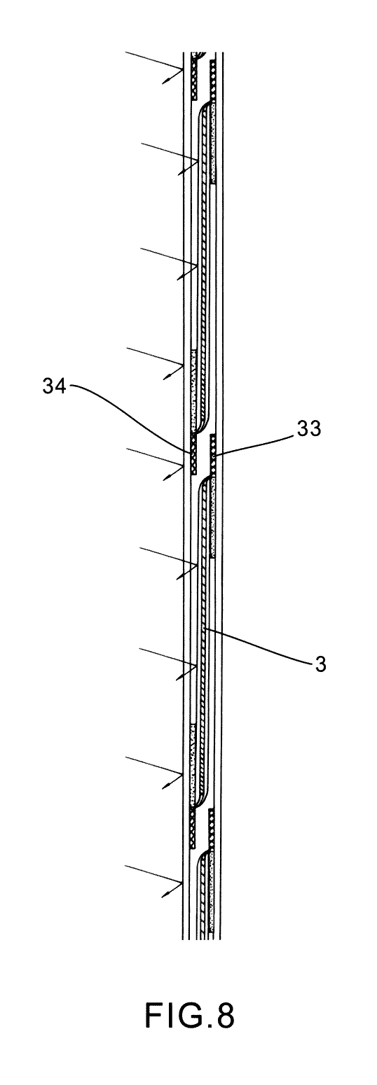

FIG. 9 is a front view of the roller curtain of the present invention according to FIG. 5, showing that the curtain-controlling reel is clockwise rotated;

FIG. 10 is a view showing that the suspending curtain sheets get closer to each other to shade the sunlight;

FIG. 11 is a perspective view showing the application of the present invention to a zebra curtain;

FIG. 12 is a perspective view showing that the suspending curtain sheets of the zebra curtain get closer to and attach to each other;

FIG. 13 is a perspective view showing that the sunlight is obstructed by the zebra curtain;

FIG. 14 is a perspective view of another embodiment of the transverse curtain sheet of the present invention;

FIG. 15 is a perspective view of still another embodiment of the transverse curtain sheet of the present invention; and

FIG. 16 is a perspective view of still another embodiment of the transverse curtain sheet of the present invention.

### DETAILED DESCRIPTION OF THE PREFERRED EMBODIMENTS

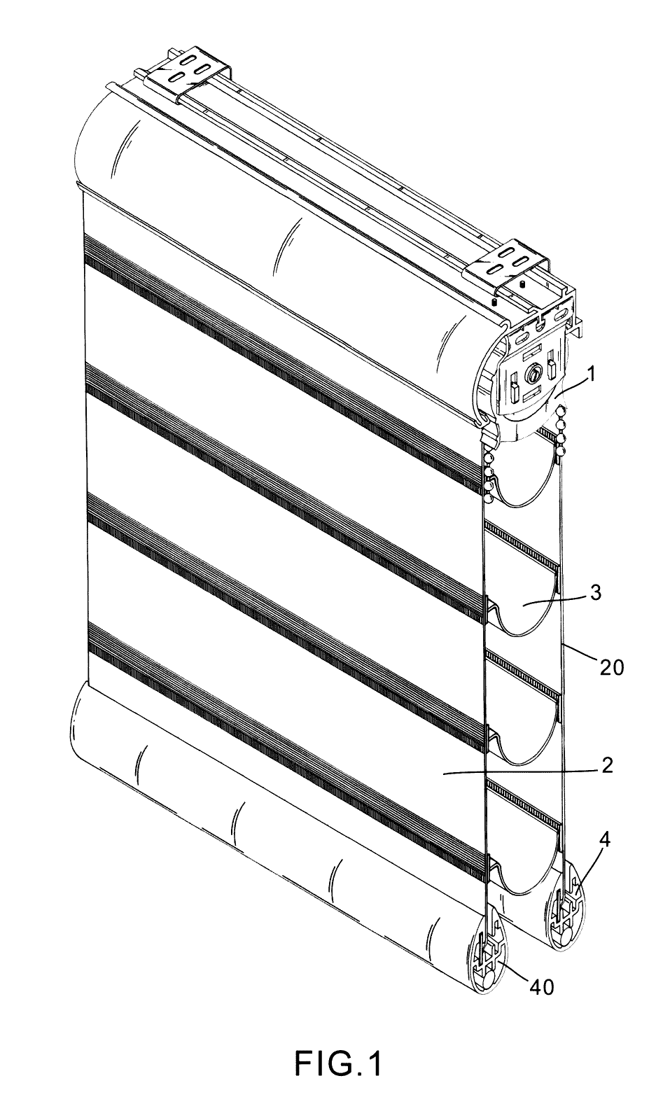

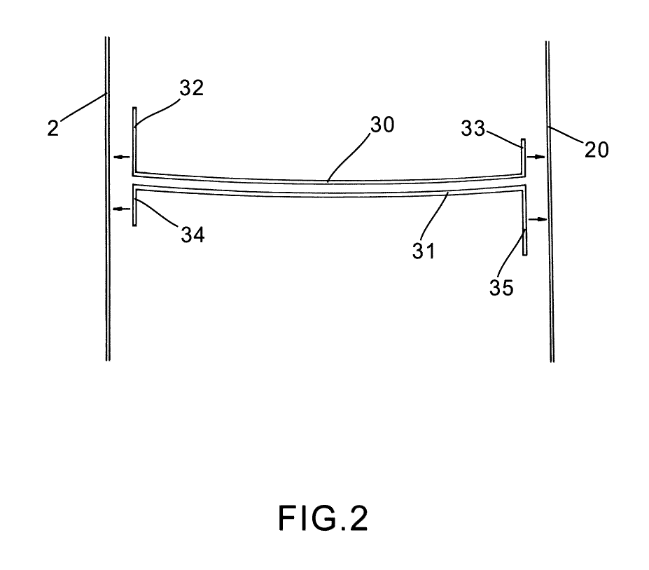

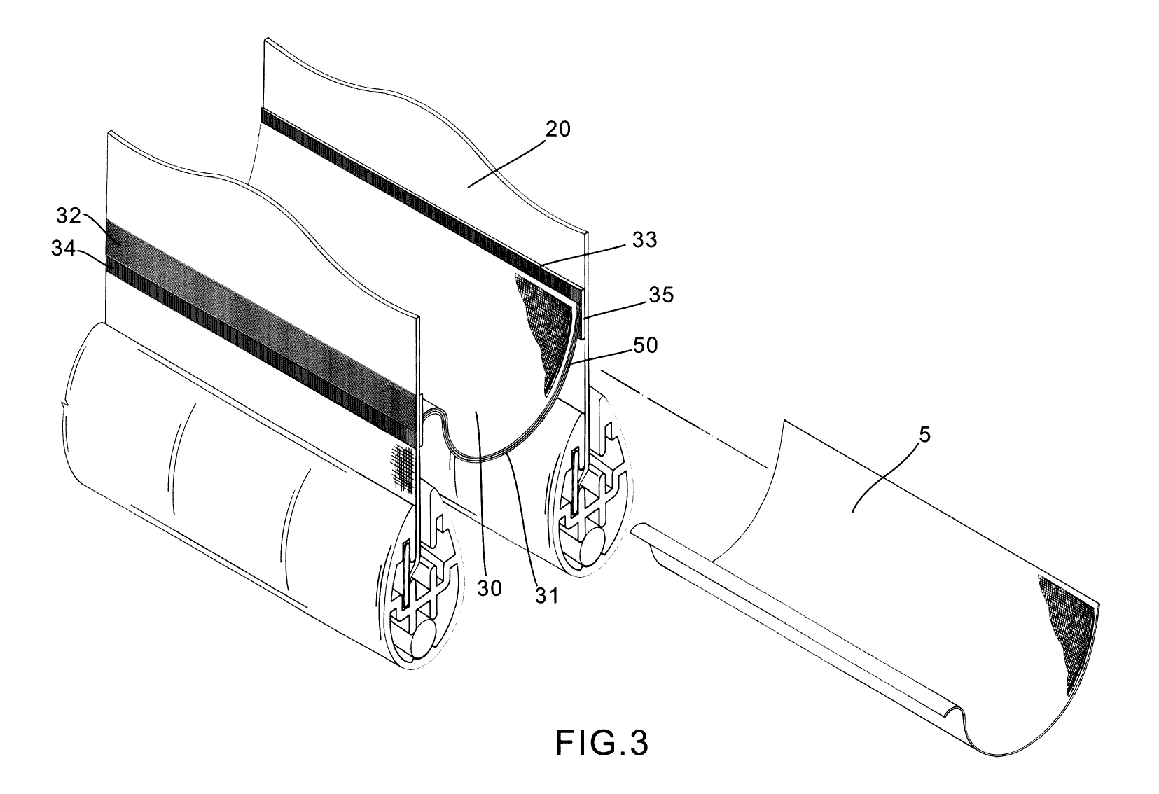

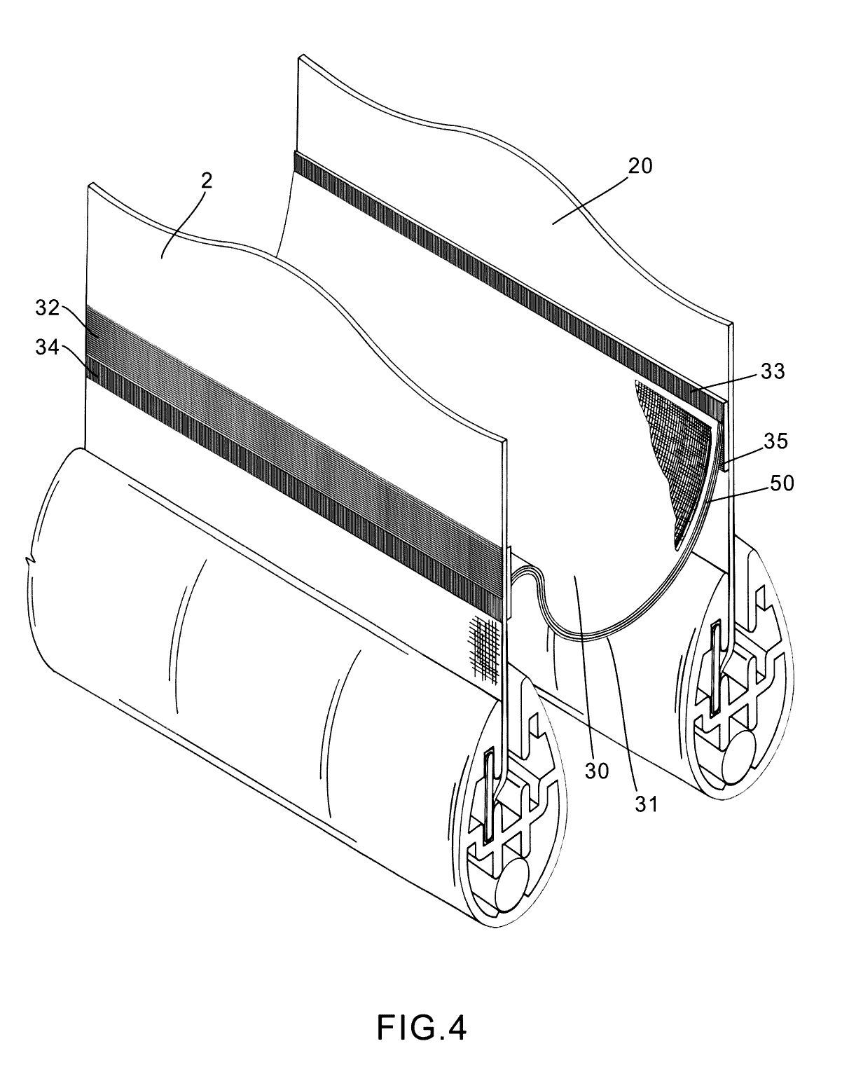

Please refer to FIG. 1. The roller curtain structure of the present invention mainly includes two suspending curtain sheets 2, 20 controlled by a rotational curtain-controlling reel 1 to move up and down, several layers of transverse curtain sheets 3 interconnected between the suspending curtain sheets 2, 20 at equal intervals, and two lower weights 4, 40 disposed at lower ends of the suspending curtain sheets 2, 20. Please refer to FIG. 2, which shows the structure of the transverse curtain sheet 3. The transverse curtain sheet 3 includes an upper sheet 30 and a lower sheet 31. Two sides of the upper sheet 30 are bent to form a large-area upward sunlight shading fabric face 32 and a small-area upward sunlight shading fabric face 33 with different areas. Two sides of the lower sheet 31 are bent to form a large-area downward sunlight shading fabric face 34 and a small-area downward sunlight shading fabric face 35 with different areas corresponding to the upper sheet 30. After the upper sheet 30 is overlaid on the lower sheet 31, the bent lateral sunlight shading fabric faces 32, 33, 34, 35 are respectively positioned in an upper position and a lower position and securely sown on the two suspending curtain sheets 2, 20. Accordingly, a receiving space 50 is defined between the upper and lower sheets 30, 31 and a nontransparent sunlight shading fabric layer 5 can be placed in the receiving space 50. According to the sunlight shading requirements, different sunlight shading fabric layers 5 with different transparencies or a totally nontransparent sunlight shading fabric layer 5 can be placed into the receiving space 50. The two suspending curtain sheets 2, 20 have different shading areas of sunlight shading fabric faces (as shown in FIGS. 3 and 4).

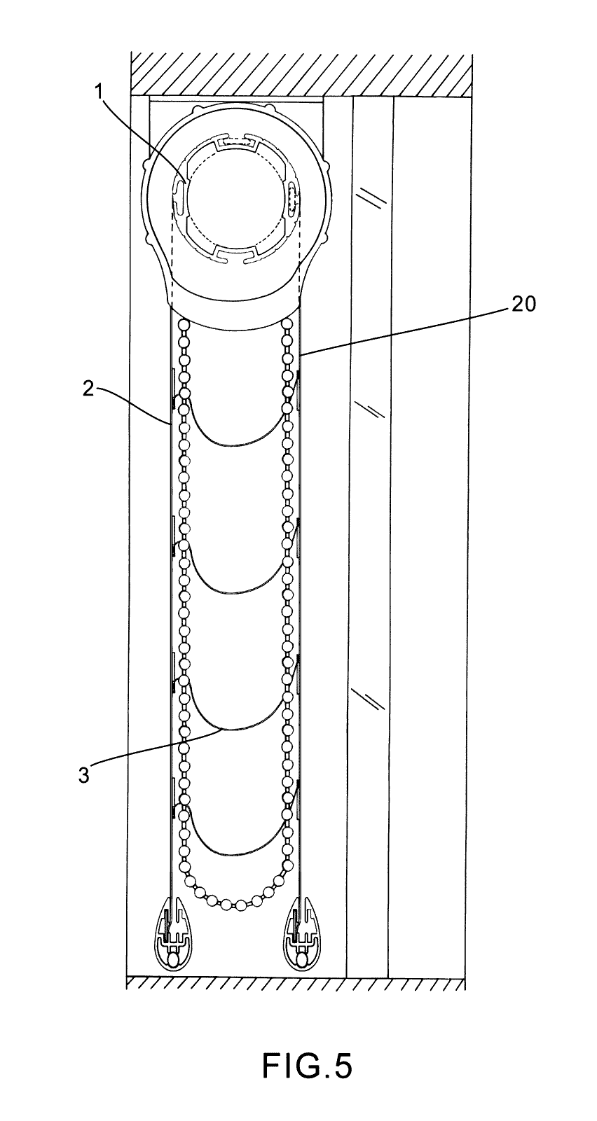

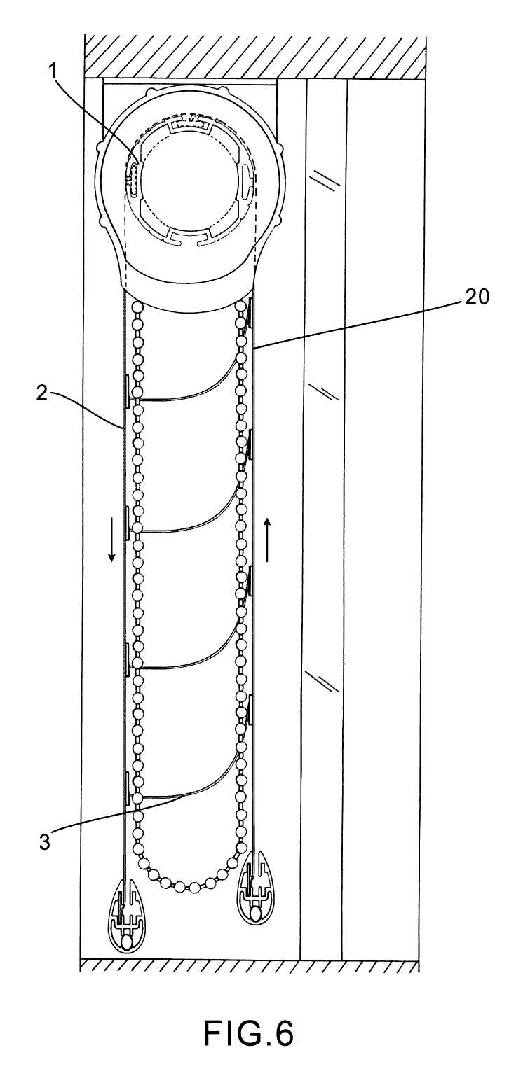

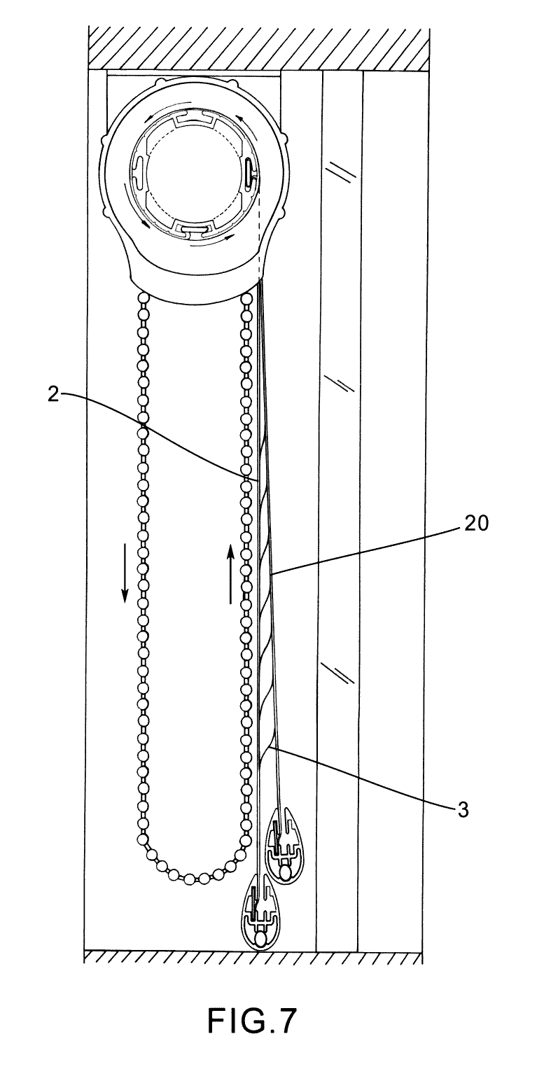

When it is desired to shade the sunlight, the curtain-controlling reel 1 is counterclockwise rotated (as shown in FIGS. 5 and 6). At this time, the suspending curtain sheet 20 on one side is wound up, while the suspending curtain sheet 2 on the other side is wound by the reel 1 to get closer to and attach to the suspending curtain sheet 20 (as shown in FIG. 7). At the same time, the transverse curtain sheets 3 are changed from a horizontal state to a vertical state. The small-area sunlight shading fabric face 34 is correspondingly overlapped with the other small-area sunlight shading fabric face 33 and the transverse curtain sheets 3 serve to shade most of the sunlight from being projected indoors. The small-area sunlight shading fabric faces 33, 34 are overlapped with each other to shade the sunlight and avoid any sunlight shading gap. In this case, the sunlight is hindered from being projected indoors and the sunlight shading effect is enhanced.

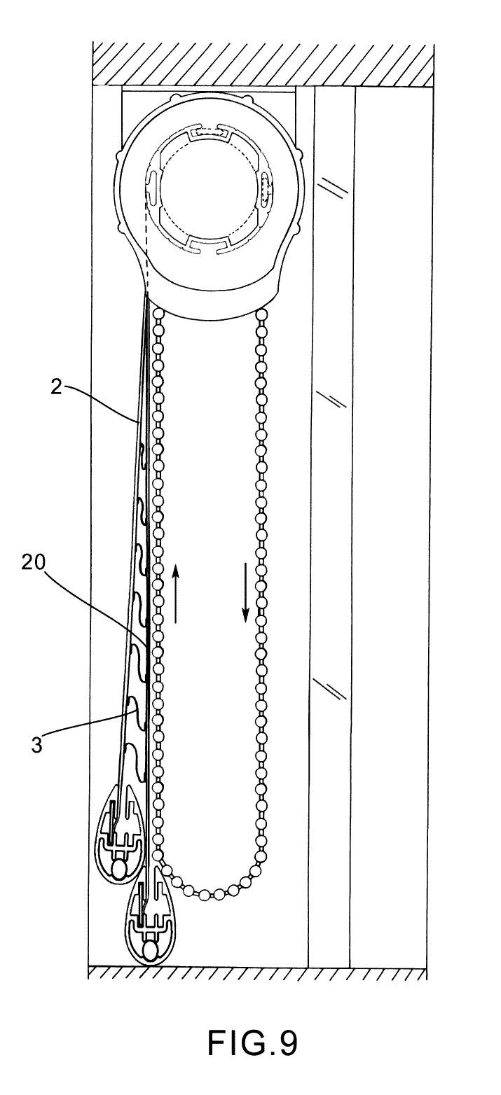

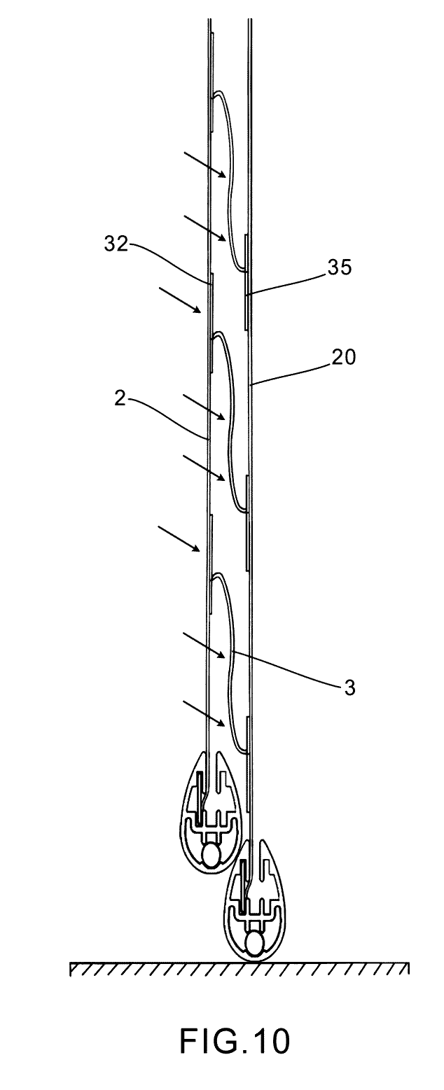

When the curtain-controlling reel 1 is clockwise rotated, the two suspending curtain sheets, 2, 20 will similarly get closer to and attach to each other to shade the sunlight (as shown in FIG. 9). At the same time, the transverse curtain sheets 3 are changed from a horizontal state to a vertical state to shade the sunlight. Similarly, the large-area sunlight shading fabric face 32 is correspondingly overlapped with the other large-area sunlight shading fabric face 35 to avoid any sunlight shading gap (as shown in FIG. 10). Therefore, according to the sunlight shading structural design of the present invention, no matter whether the curtain-controlling reel 1 is counterclockwise rotated or clockwise rotated, the sunlight shading curtain has no sunlight shading gap so that the sunlight shading effect is greatly enhanced.

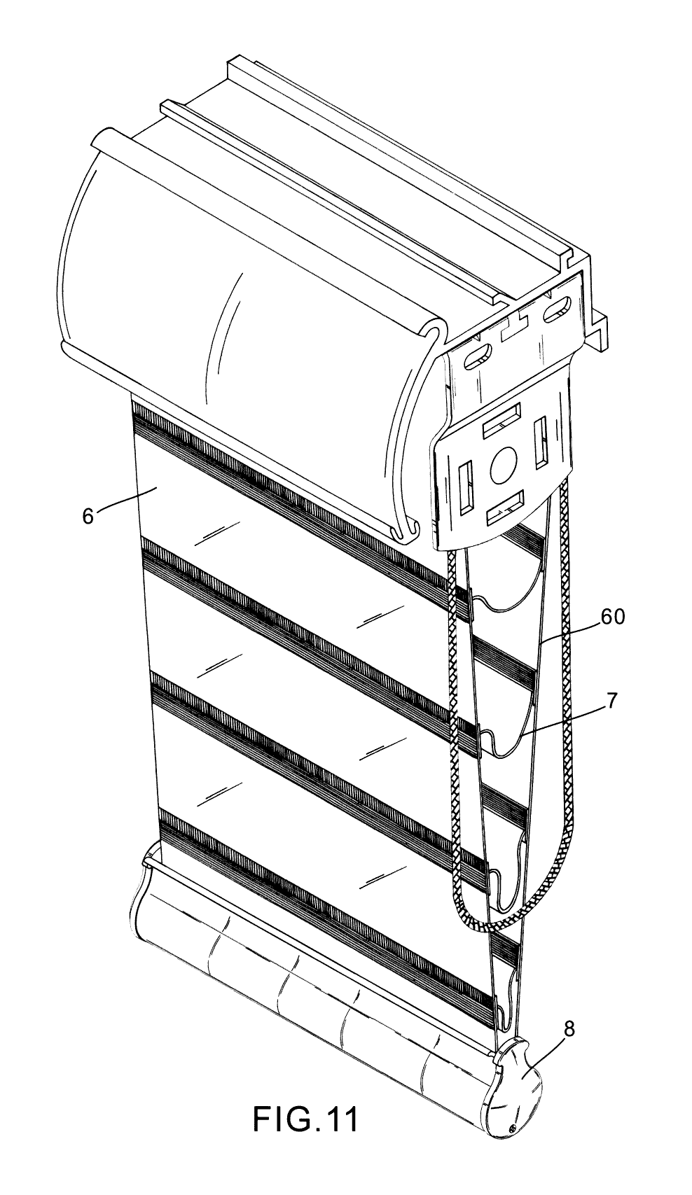

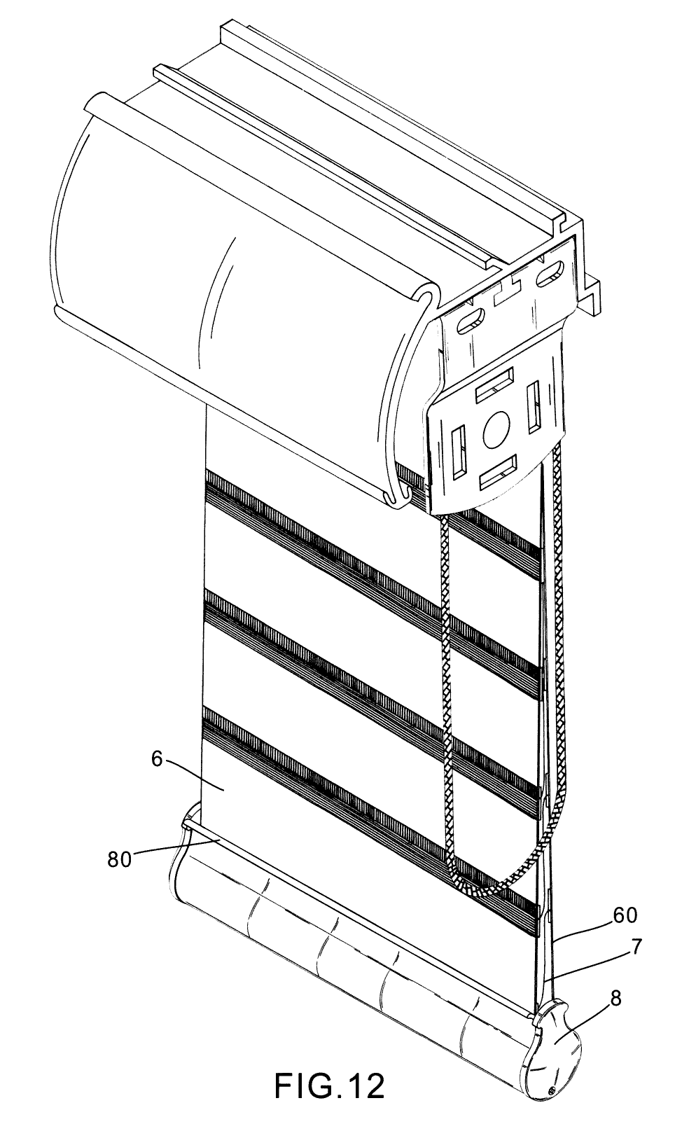

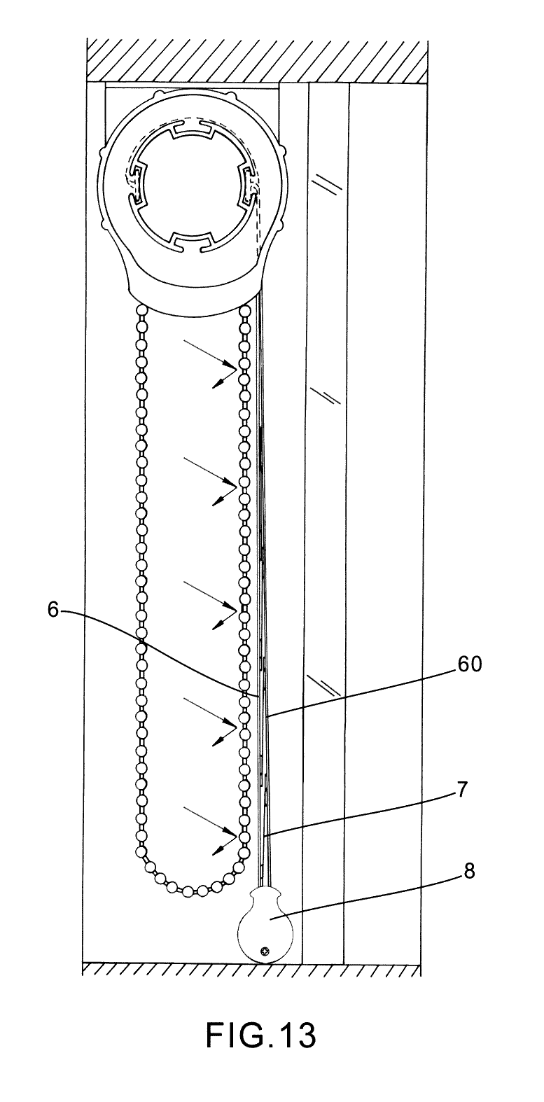

Please now refer to FIG. 11, which shows the application of the present invention to a zebra curtain. The zebra curtain includes two suspending curtain sheets 6, 60, several layers of transverse curtain sheets 7 interconnected between the suspending curtain sheets 6, 60 at equal intervals, and a lower weight 8 for the two suspending curtain sheets 6, 60 to pass over and connect therewith. The structure of the transverse curtain sheet 7 is as the structure of the transverse curtain sheet 3 of the above roller curtain. The upper sheet is overlaid on the lower sheet and two sides of the upper and lower sheets are securely sown on the two suspending curtain sheets 6, 60. The lower weight 8 serves to stabilize the up and down displacement of the curtain and avoid shake of the curtain. Especially, an outward flange 80 is formed at an open end of the lower weight 8 (as shown in FIG. 12). When the lower weight 8 shakes, the outward flange 80 serves to guide and set the lower weight 8 upright so as to stably wind the curtain sheets. After the two suspending curtain sheets get closer to and attach to each other, the curtain provides a sunlight shading effect (as shown in FIG. 13).

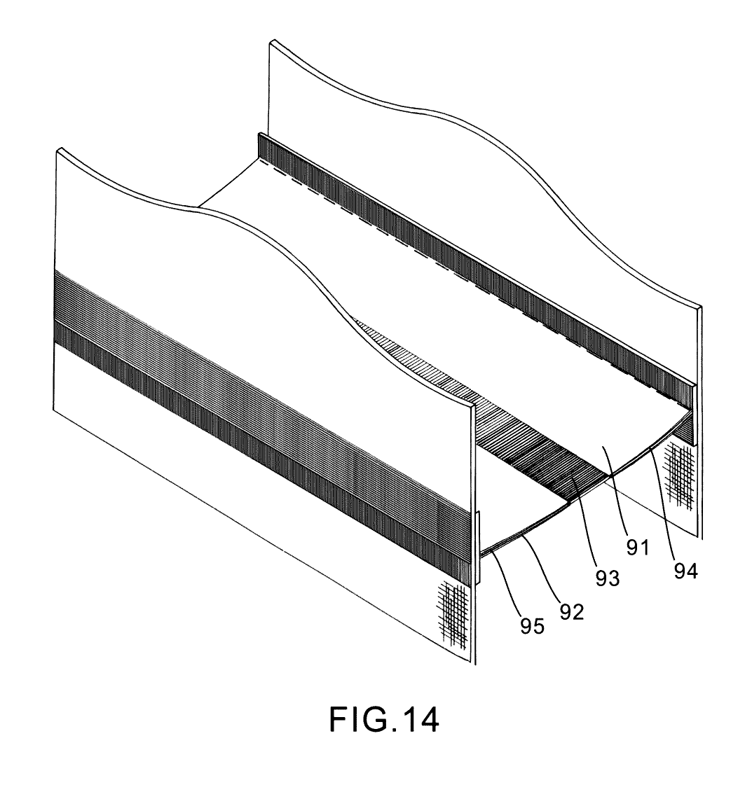

Please now refer to FIG. 14, which shows another embodiment of the transverse curtain sheet of the present invention. In this embodiment, a connection fabric face 93 is connected between the upper and lower sheets 91, 92 to form two receiving spaces 94, 95 between the upper and lower sheets 91, 92. Different fabric layers with different sunlight shading effects can be placed into the receiving spaces 94, 95 to achieve different sunlight shading effect.

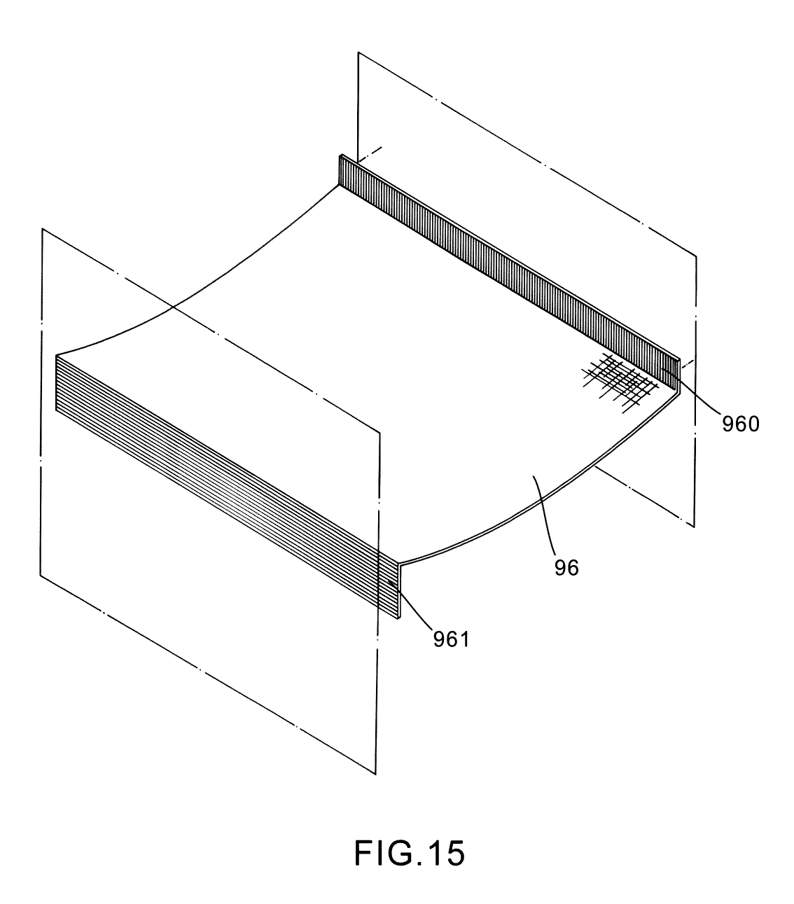

Please now refer to FIG. 15, which shows still another embodiment of the transverse curtain sheet of the present invention. In this embodiment, two sides of a transverse curtain sheet 96 are bent to form two sunlight shading fabric faces 960, 961 with different shading areas. The two sunlight shading fabric faces 960, 961 are sown on the two suspending curtain sheets 962, 963 with one directed upward, while the other directed downward. When shading the sunlight, the sunlight shading fabric faces 960, 961 are similarly overlapped with each other to avoid any sunlight shading gap. In this case, the sunlight shading effect is enhanced.

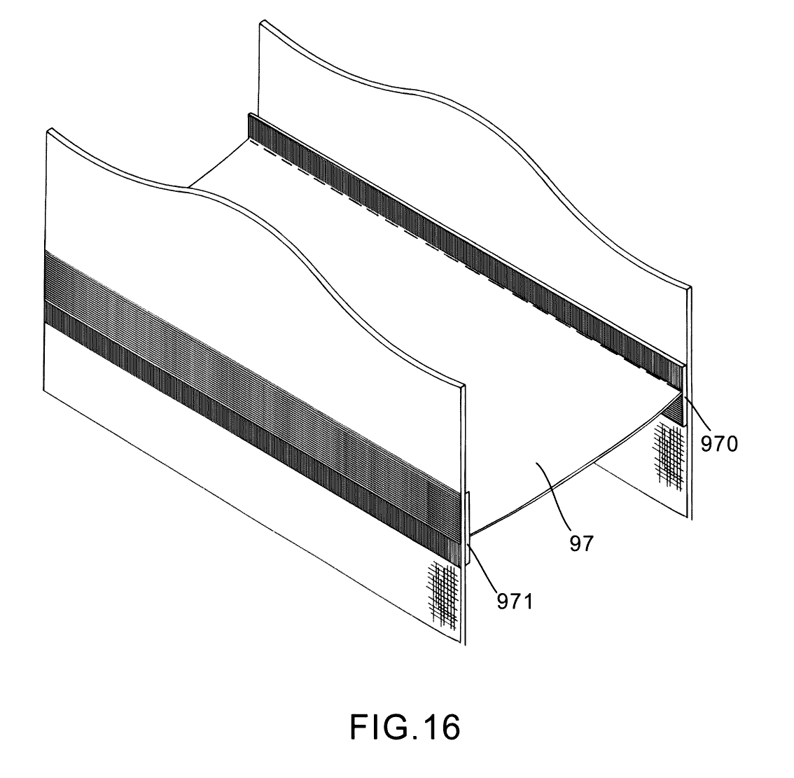

Please now refer to FIG. 16, which shows still another embodiment of the transverse curtain sheet of the present invention. In this embodiment, two sunlight shading fabric faces 970, 971 are respectively sown with two sides of the transverse curtain sheet 97. The two sides of the transverse curtain sheet 97 are sown on the sunlight shading fabric faces 970, 971 in different sewing positions at different heights. Therefore, the sunlight shading fabric faces 970, 971 form different shading areas in an upper position and a lower position. When shading the sunlight, the sunlight shading fabric faces 970, 971 are overlapped with each other to avoid any sunlight shading gap. In this case, the sunlight shading effect is enhanced.

The above embodiments are only used to illustrate the present invention, not intended to limit the scope thereof. Many modifications of the above embodiments can be made without departing from the spirit of the present invention.

1-8. (canceled)

9. A roller curtain structure comprising:
two suspending curtain sheets controlled by a curtain-controlling reel and being movable between an upward position and a downward position;
a plurality of transverse curtain sheets interconnected between the suspending curtain sheets at equal intervals, each transverse curtain sheet of the plurality of transverse curtain sheets including an upper sheet, a lower sheet, and a receiving space, each sheet of the upper sheet and the lower sheet having two bent sections and a middle section located between the two bent sections, the two bent sections including a first bent section and a second bent section are located on two opposing side portions of the upper sheet and the lower sheet respectively, the receiving space is located between the middle section of the upper sheet and the middle section of the lower sheet and has a non-transparent sunlight shading fabric layer inserted therein, the first bent section of the upper sheet and the first bent section of the lower sheet of each said transverse curtain sheet of the plurality of transverse curtain sheets being connected to a first suspending curtain sheet of the two suspending curtain sheets and the second bent section of the upper sheet and the second bent section of the lower sheet of each said transverse curtain sheet of the plurality of transverse curtain sheets being connected to a second suspending curtain sheet of the two suspending curtain sheets, sunlight shading areas are formed on the two suspending curtain sheets where the two bent sections of the upper sheet and the lower sheet of the plurality of transverse curtain sheets are connected to the two suspending curtain sheets; and
at least one lower weight connected to a lower end of each of the two suspending curtain sheets,
wherein, the two suspending curtain sheets are moveable between an open position and closed position, when the two suspending curtain sheets are located in the open position, the two suspending curtain sheets are spaced apart and the plurality of transverse curtain sheets are located in a horizontal position, when the two suspending curtain sheets are located in the closed position, the two suspending curtain sheets engaging and the plurality of transverse curtain sheets are located in a vertical position, the sunlight shading areas of the two suspending curtain sheets are located in an overlapping position for blocking sunlight.

10. The roller curtain structure according to claim 9, wherein each transverse curtain sheet of the plurality of transverse curtain sheets is a slightly downward curved structure.

11. The roller curtain structure according to claim 9, wherein more than one receiving space is defined between the upper sheet and the lower sheet of the transverse curtain sheet.

12. The roller curtain structure according to claim 9, wherein each transverse curtain sheet of the plurality of transverse curtain sheets is made of transparent soft texture material.

13. The roller curtain structure according to claim 9, wherein an outward flange is formed along a length of an open end of the at least one lower weight.

14. The roller curtain structure according to claim 9, wherein the first bent section and the second bent section of the corresponding sheet of the upper sheet and the lower sheet of each transverse curtain sheet of the plurality of transverse curtain sheets are sewn at different sewing heights on the first suspending curtain sheet and the second suspending curtain sheet respectively.

15. The roller curtain structure according to claim 9, wherein the first bent section and the second bent section of the corresponding sheet of the upper sheet and the lower sheet of each transverse curtain sheet of the plurality of transverse curtain sheets have different heights.

16. The roller curtain structure according to claim 9, wherein the first bent section and the second bent section of the corresponding sheet of the upper sheet and the lower sheet of each transverse curtain sheet of the plurality of transverse curtain sheets extend upwardly and downwardly in opposite directions.

17. The roller curtain structure according to claim 9, wherein the first bent section and the second bent section of the corresponding sheet of the upper sheet and the lower sheet of each transverse curtain sheet of the plurality of transverse curtain sheets extend upwardly or downwardly in a same direction.

18. The roller curtain structure according to claim 9, wherein the first bent section and the second bent section of the upper sheet of each transverse curtain sheet of the plurality of transverse curtain sheets extend upwardly and the first bent section and the second bent section of the lower sheet of each transverse curtain sheet of the plurality of transverse curtain sheets extend downwardly.

19. The roller curtain structure according to claim 9, wherein the at least one lower weight includes two lower weights, one lower weight of the two lower weights is connected to the lower end of each of the two suspending curtain sheets.
